(19) United States
(12) Patent Application Publication
(10) Pub. No.: US 2009/0072696 A1
(43) Pub. Date: Mar. 19, 2009

(54) CERAMIC LAMP HOLDER

(76) Inventor: Richard LEE, Taipei (TW)

Correspondence Address: HDLS Patent & Trademark Services, P.O. BOX 220746, CHANTILLY, VA, 20153-0746, US

(21) Appl. No.: 12/164,341

(22) Filed: Jun. 30, 2008

(30) Foreign Application Priority Data
Sep. 14, 2007 (TW) 096215478

(51) Int. Cl. H01J 5/48

(52) U.S. Cl. 313/318.01

(57) ABSTRACT

A ceramic lamp holder for connecting a bulb and communicating with a filament of the bulb includes a cylinder and a conductive terminal. The cylinder is made of ceramic material with its one side formed into a closed end. The closed end is provided with a through hole for allowing one end of the filament to pass through. The outer surface of the cylinder is formed with an outer thread and a trough recessed into the surface of the outer thread. The conductive terminal is fixedly received in the trough to be partially exposed to the surface of the outer thread. One end of the conductive terminal is connected to the other end of the filament. Via the above arrangement, the wear caused by the friction between the conductive terminal and the lamp socket can be reduced, and the contact effect and the life time of the lamp holder can be increased.

### BACKGROUND OF THE INVENTION

1. Field of the Invention

The present invention relates to a lamp, and in particular to a lamp holder for connecting a bulb.

2. Description of Prior Art

Taiwan Patent Publication No. M258232 discloses a conventional lamp holder, which includes an outer connecting piece, an inner connecting piece and an insulating ring. The outer connecting piece is made of a metallic material such as copper and partially covers the outer surface of the insulating ring. The outer peripheral surface of the outer connecting piece is formed with an outer thread. The inner connecting piece and the outer connecting piece are separated from each other and are connected to the center of the top of the insulating ring. With the inner connecting piece and the outer connecting piece being welded with an inner filament and an outer filament of the bulb respectively, the assembly of the bulb and the lamp holder can be achieved.

However, in practice, the above-mentioned conventional lamp holder still has some problems as follows. Since the outer thread of the outer connecting piece is connected to the inner thread (not shown) of the lamp socket via full circles of rotation, the wear caused by the friction between the outer thread and the inner thread is so large that the contact therebetween may become poor after several times of rotation. Furthermore, there is a number of constituent components, so that the manufacture cost and material cost of those components are increased. Also, a large amount of labor hours should be spent to assemble the conventional lamp holder. On the other hand, the inner connecting piece and the outer connecting piece cannot withstand high temperature very well. Therefore, after operating continuously for a long time, the inner connecting piece and the outer connecting piece may be overheated to suffer damage, which lowers the lifetime thereof.

Therefore, it is an important issue to overcome the above-mentioned problems in prior art.

### SUMMARY OF THE INVENTION

The present invention is to provide a ceramic lamp holder, in which a conductive terminal is received in a trough of a cylinder. In this way, when the cylinder is rotated into a lamp socket, the wear caused by the friction between the conductive terminal and the lamp socket can be reduced, thereby increasing the contact effect and lifetime.

The present invention is to provide a ceramic lamp holder for connecting a bulb and communicating with a filament of the bulb, which includes a cylinder and a conductive terminal. The cylinder is made of a ceramic material with its one side formed into a closed end. The closed end is provided with a through hole for allowing one end of the filament to pass through. The outer surface of the cylinder is formed with an outer thread and a trough recessed into the surface of the outer thread. The conductive terminal is fixedly received in the trough to be partially exposed to the outer surface of the outer thread. One end of the conductive terminal is connected to the other end of the filament.

The present invention is to provide a ceramic lamp holder, in which the cylinder is made of a ceramic material that can withstand a higher temperature and dissipate the heat of the filament or bulb quickly, thereby increasing the lifetime of the bulb.

The present invention is to provide a ceramic lamp holder, which is simple in structure and can be assembled easily. Furthermore, the present invention can reduce the material cost and the manufacture cost substantially.

### BRIEF DESCRIPTION OF THE DRAWINGS

FIG. 1 is an exploded perspective view of the present invention;

FIG. 2 is an assembled view of the present invention;

FIG. 3 is an assembled cross-sectional view of the present invention;

FIG. 4 is an assembled view showing the external appearance of the present invention being connected with a bulb; and

FIG. 5 is an assembled cross-sectional view showing the present invention being connected with a bulb.

### DETAILED DESCRIPTION OF THE INVENTION

The detailed description and technical contents of the present invention will be explained with reference to the accompanying drawings. However, the drawings are illustrative only, but not used to limit the present invention.

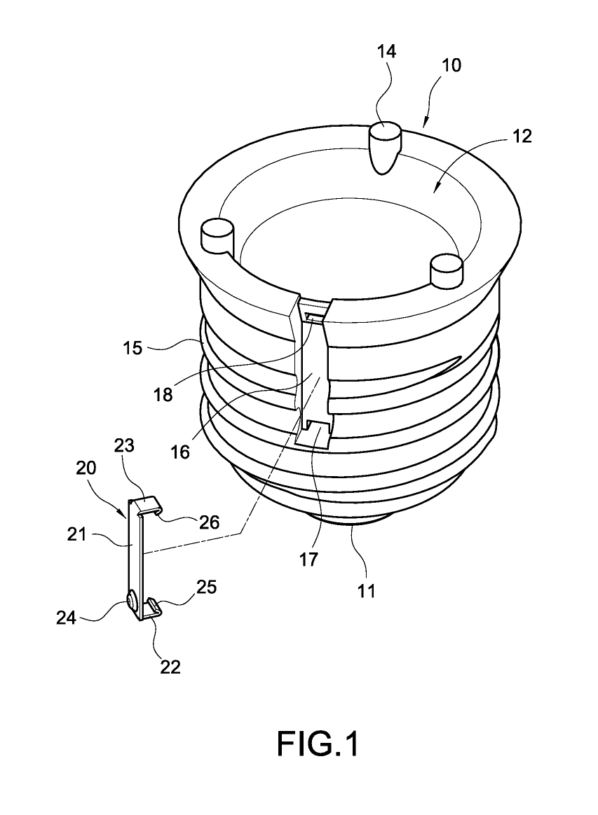

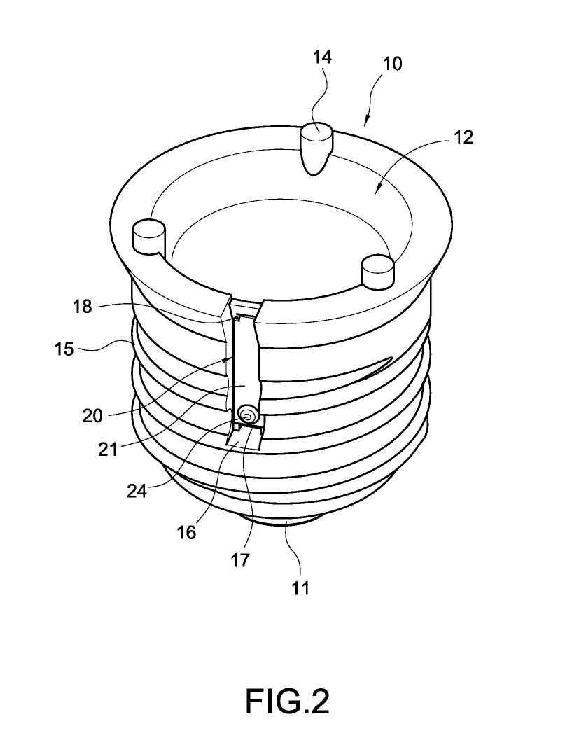

Please refer to FIG. 1 to 3. FIGS. 1, 2 and 3 are an exploded perspective view, an assembled view and an assembled cross-sectional view of the present invention respectively. The present invention provides a ceramic lamp holder, which includes a cylinder 10 and a conductive terminal 20.

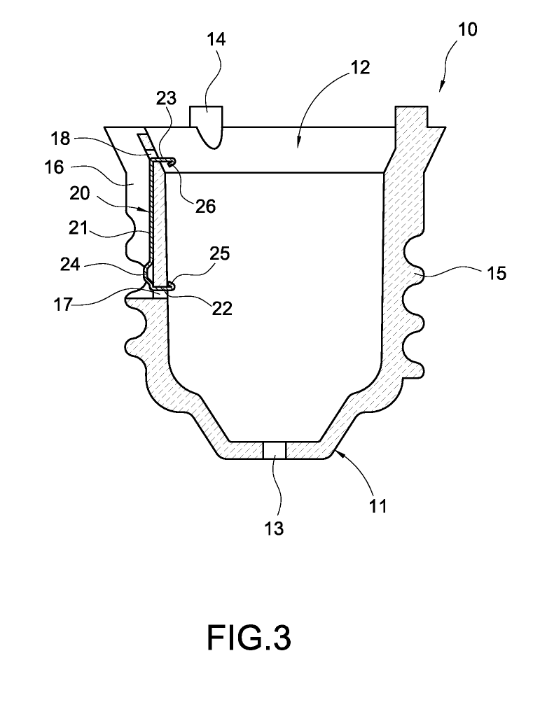

The cylinder 10 is made of a ceramic material and is formed into a circular shape. Both sides of the cylinder 10 are formed into a conical closed end 11 and an open end 12. The center of the closed end 11 is provided with a through hole 13 (FIG. 3). The periphery of the open end 12 of the cylinder 10 is formed with a plurality of outwardly-extending insertion posts 14. The outer periphery of the cylinder 10 is formed with an outer thread 15 and a trough 16 recessed into the surface of the outer thread 15. The inner wall surface of the trough 16 is provided respectively with a first fixing hole 17 and a second fixing hole 18 each penetrating the interior of the cylinder 10.

The conductive terminal 20 is made of a metallic material having good electric conductivity (such as copper). The conductive terminal 20 is constituted by an upright conducting section 21 and two fixing sections 22, 23 extending vertically respectively from both ends of the conducting section 21. The lower portion of the conducting section 21 protrudes to form a conducting point 24. The distal end of each fixing section 22, 23 is bent inwardly to form a hook 25, 26 respectively. The conductive terminal 20 is received in the trough 16 with the fixing sections 22, 23 penetrating into the fixing holes 17, 18 respectively. In this way, the hooks 25, 26 are fixed to the inner wall of the cylinder 10 respectively while the conducting point 24 is exposed to the outer peripheral surface of the outer thread 15.

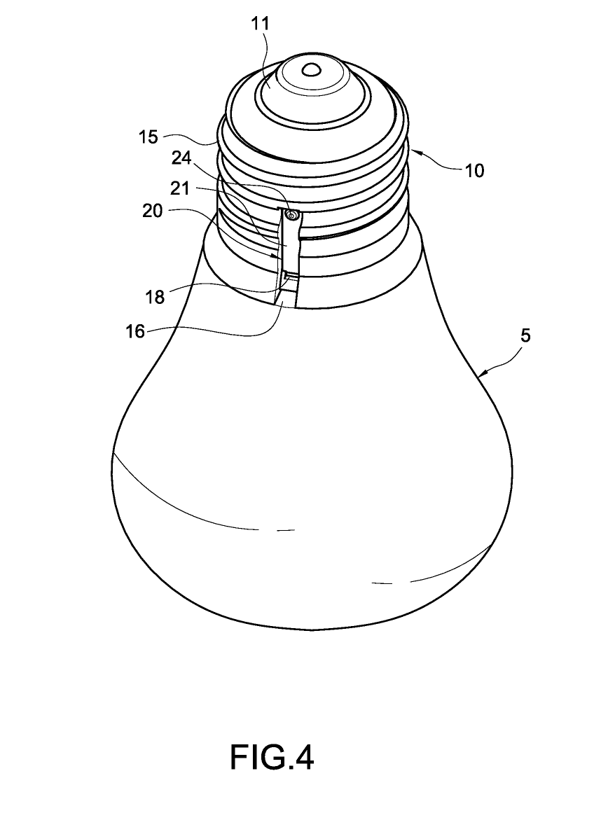

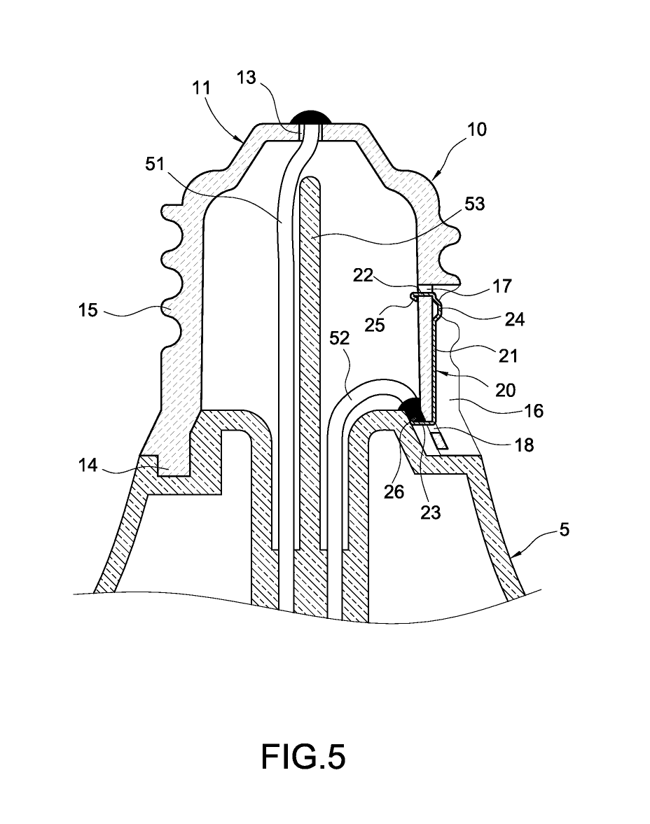

FIGS. 4 and 5 are an assembled view and an assembled cross-sectional view showing the present invention being connected with the bulb respectively. The lamp holder of the present invention is used to connect with a bulb 5. The bulb 5 has therein an inner filament 51 and an outer filament 52 as well as a central post 53 for separating the inner filament 51 from the outer filament 52. In assembling, the inner filament 51 passes through the through hole 13. Then, after the fixing section 23 of the conductive terminal 20 is welded with the outer filament 52, the fixing sections 22, 23 penetrate into the first and second fixing holes 17, 18 respectively. As a result, the hooks 25, 26 are fixed to the inner wall of the cylinder 10 with the respective insertion posts 14 are inserted into holes of the bulb 5. Finally, the inner filament 51 is welded into the through hole 13, thereby completing the connection between the lamp holder and the bulb 5.

According to the above, the ceramic lamp holder of the present invention already has industrial applicability, novelty and inventive steps. Furthermore, the structure of the present invention has not been seen in products of the same kind or put into public use. Therefore, the present invention conforms to the requirements for a utility model patent.

What is claimed is:

1. A ceramic lamp holder for connecting to a bulb and communicating with a filament of the bulb, comprising:
a cylinder made of a ceramic material, one side of the cylinder being formed into a closed end, the closed end being provided with a through hole for allowing an end of the filament to pass through, an outer periphery of the cylinder being formed with an outer thread and a trough recessed into the surface of the outer thread; and
a conductive terminal received in the trough of the cylinder and partially exposed to the outer surface of the outer thread, one end of the conductive terminal being connected to the other end of the filament.

2. The ceramic lamp holder according to claim 1, wherein the cylinder is formed into a circular shape.

3. The ceramic lamp holder according to claim 2, wherein the closed end is formed into a conical shape.

4. The ceramic lamp holder according to claim 1, wherein one side of the cylinder away from the closed end is formed into an open end, a periphery of the open end is formed with a plurality of outwardly-extending insertion posts for connecting with the bulb.

5. The ceramic lamp holder according to claim 1, wherein the conductive terminal comprises a conducting section, one side of the conducting section protrudes to form a conducting point, and the conducting point is exposed to the surface of the outer thread.

6. The ceramic lamp holder according to claim 5, wherein the conductive terminal further comprises two fixing sections extending from both ends of the conducting section, the trough is provided therein with a first fixing hole and a second fixing hole penetrating an interior of the cylinder, and the two fixing sections penetrate into the first and second fixing holes respectively.

7. The ceramic lamp holder according to claim 6, wherein the distal ends of the two fixing sections are bent to form hooks respectively for connecting to the inner wall surface of the cylinder.
